(19) United States
(12) Patent Application Publication
(10) Pub. No.: US 2025/0251013 A1
(43) Pub. Date: Aug. 7, 2025

(54) FASTENER

(71) Applicant: GM Global Technology Operations LLC, Detroit, MI (US)

(72) Inventor: Kevin Updike, Canton, MI (US)

(73) Assignee: GM Global Technology Operations LLC, Detroit, MI (US)

(21) Appl. No.: 18/433,025

(22) Filed: Feb. 5, 2024

(51) Int. Cl. F16B 39/26

(52) U.S. Cl. CPC F16B 39/26

(57) ABSTRACT

A fastener including a nut having a nut body including a threaded through hole extending along a longitudinal axis and a flange extending away from the nut body and including an upper surface and a lower surface, and a retainer ring integrally formed with the nut and including a retention feature having a contact surface extending away from the nut body and an annular lip perpendicular to the longitudinal axis and extending away from the nut body.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a fastener, and more particularly, to a fastener having a retainer ring for temporarily securing a component to the fastener.

In manufacturing, an operator's ability to assemble certain components can be limited due to the size and/or weight of the components, for instance. Additional tooling or so-called “third hand” devices may be developed and provided to aid operators during manufacturing. However, these solutions can add undesirable cycle time during manufacturing processes and add to the overall complexity associated with assembly operations. These shortcomings, as well as others, are addressed by principles of the present disclosure.

### SUMMARY

In one configuration, a fastener includes a nut including a nut body comprising a threaded through hole extending along a longitudinal axis, a flange extending away from the nut body and comprising an upper surface and a lower surface, and an annular notch comprising a notch diameter and a notch thickness and arranged in the nut body, the annular notch being spaced axially from the flange with respect to the longitudinal axis. The fastener further includes a retainer ring arranged in the annular notch and including a washer portion comprising an inner diameter, an outer diameter, and a thickness and one or more retention features coupled to and depending from the washer portion in a first position. The one or more retention features are configured to deflect between the first position and a second position and return to the first position.

The fastener may include one or more of the following optional aspects. For example, the nut body may be cylindrical.

According to one aspect, the nut body may be hexagonal.

In at least one example, the lower surface of the flange may be configured to be welded, glued, heat staked, or compression mounted to another component.

In another example, the retainer ring may be fixed in the annular notch by a collar such that the retainer ring does not rotate about the longitudinal axis with respect to the nut.

According to another aspect, the retainer ring may be made of a spring metal material.

According to another example, the nut may be made of metal, plastic, or hard rubber material.

According to at least one aspect, the one or more retention features depend away from the longitudinal axis and toward the flange.

In at least one example, the one or more retention features may include a curved portion and an end surface that is generally parallel to the flange.

According to another example, the one or more retention features may be configured to retain a component laterally with respect to the nut and axially with respect to the longitudinal axis.

In another configuration, a fastener includes a nut including a nut body comprising a threaded through hole extending along a longitudinal axis, a flange extending away from the nut body and comprising an upper surface and a lower surface, and an annular notch comprising a notch diameter and a notch thickness and arranged in the nut body, the annular notch being spaced axially from the flange with respect to the longitudinal axis. The fastener further includes a retainer ring arranged in the annular notch and including a washer portion comprising an inner diameter, an outer diameter, and a thickness and a retention feature coupled to and depending away from the washer portion and axially away from the flange.

The fastener may include one or more of the following optional aspects. For example, the retention feature may include a curved portion and an end surface that is parallel to the flange.

According to one aspect, the retention feature may be configured to temporarily support a component being secured to the fastener.

In at least one example, the retention feature may be configured to support a component to prevent inadvertent axial movement of the component toward the flange with respect to the longitudinal axis and inadvertent lateral movement of the component with respect to the nut.

In another configuration, a fastener includes a nut including a nut body comprising a threaded through hole extending along a longitudinal axis and a flange extending away from the nut body and comprising an upper surface and a lower surface. The fastener further includes a retainer ring integrally formed with the nut comprising a retention feature, comprising a contact surface extending away from the nut body, and an annular lip perpendicular to the longitudinal axis and extending away from the nut body.

The fastener may include one or more of the following optional aspects. For example, the nut and the retainer ring may be made of a metal, hard plastic, or hard rubber material.

According to one aspect, the contact surface may be angled with respect to the longitudinal axis and configured to deflect a component being attached to the fastener. The contact surface may locate the fastener within an opening of the component and distribute a load on one or more portions of the opening.

According to at least one example, the annular lip axially retains a portion of a component attached to the fastener with respect to the longitudinal axis. The component may be laterally retained with respect to the nut body.

### BRIEF DESCRIPTION OF THE DRAWINGS

The drawings described herein are for illustrative purposes only of selected configurations and are not intended to limit the scope of the present disclosure.

FIG. 1 is a perspective view of a fastener according to principles of the present disclosure;

FIG. 2 is a top view of the fastener of FIG. 1 according to principles of the present disclosure;

FIG. 3 is an exploded cross-sectional view of the fastener of FIG. 1, a first vehicle component, a second vehicle component, and a bolt according to principles of the present disclosure;

FIG. 4 is a cross-sectional view of the fastener of FIG. 1, the first vehicle component, the second vehicle component, and the bolt according to principles of the present disclosure;

FIG. 5 is a cross-sectional view of the fastener of FIG. 1, the first vehicle component, the second vehicle component, and the bolt assembled to the fastener according to principles of the present disclosure;

FIG. 6 is a perspective view of a fastener with an unfinished collar according to principles of the present disclosure;

FIG. 7 is a perspective view of the fastener of FIG. 6 according to principles of the present disclosure;

FIG. 8 is a perspective view of a fastener according to principles of the present disclosure;

FIG. 9 is a perspective view of a fastener according to principles of the present disclosure; and

FIG. 10 is a perspective view of the fastener of FIG. 9 assembled to a component according to principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

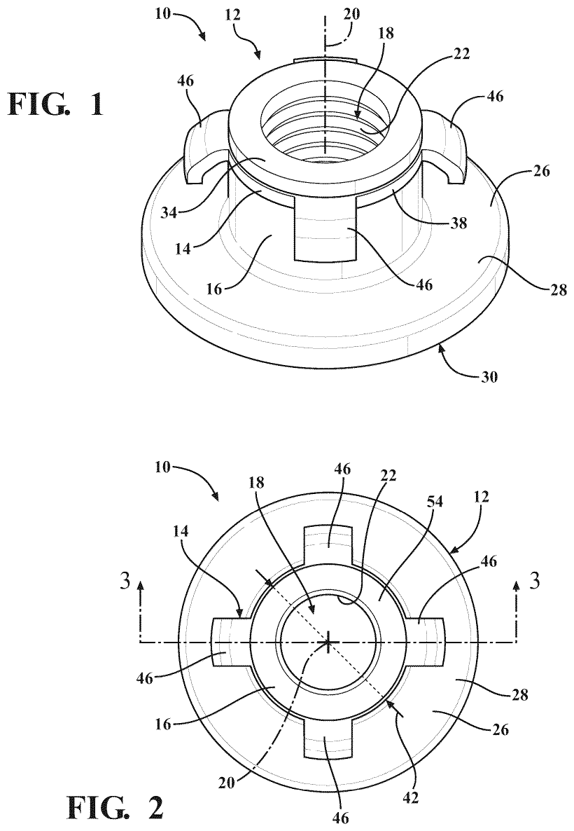

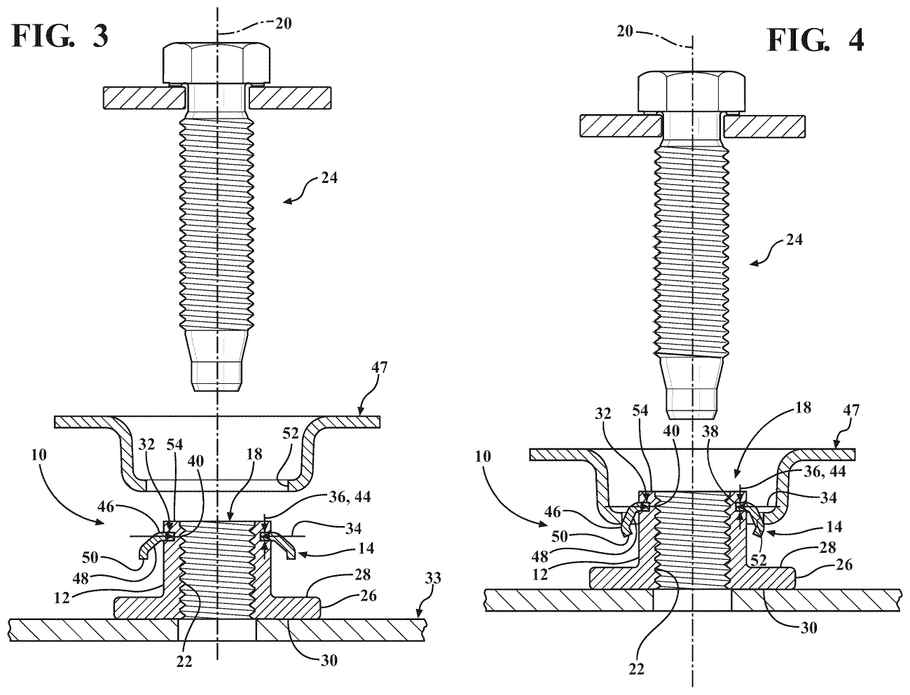

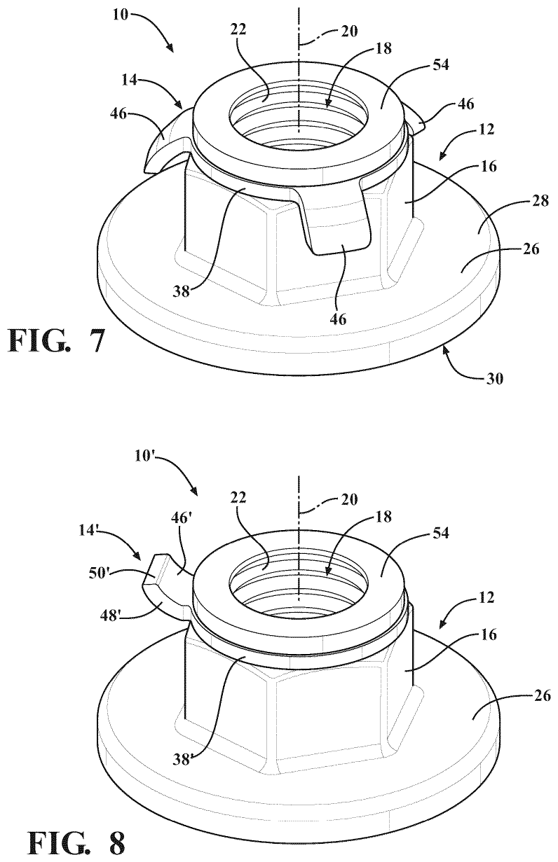

Referring to FIGS. 1 and 2, a fastener 10 is provided including a nut 12 and a retainer ring 14. The nut 12 includes a nut body 16 that can be cylindrical, as shown in FIG. 1. In another example, as shown in FIGS. 6 and 7, the nut body 16 may be a hexagon shape or another polygon shape (e.g., square, octagon, etc.). The nut body 16 includes a through hole 18 extending along a longitudinal axis 20. The through hole 18 can include threads 22, which are configured to correspond with threads of a bolt 24 (FIG. 4) or another fastener. The nut 12 can have a flange 26 extending radially away from the nut body 16 and including an upper surface 28 and a lower or mating surface 30, as shown in FIG. 3. The lower surface 30 may be configured so that the nut 12 may be welded, glued, heat staked, compression mounted, or otherwise coupled to another component, such as a first vehicle component 33 (FIG. 3). With continued reference to FIG. 3, the nut 12 can include a notch, such as an annular notch 32, in the nut body 16 that is configured to capture or otherwise support the retainer ring 14. The annular notch 32 may be defined by a notch diameter 34 and a notch thickness 36. According to at least one aspect of the present disclosure, the nut 12 may be made of metal material (e.g., steel), plastic material, a hard rubber material, or another material used for fasteners in the automotive industry, for example.

With reference to FIG. 3, the retainer ring 14 has a washer portion 38 including an inner diameter 40, an outer diameter 42, and a thickness 44. The inner diameter 40 may be configured to correspond with the notch diameter 34 of the nut body 16. Also, the thickness 44 of the retainer ring 14 may be selected according to the notch thickness 36. In the example shown in FIG. 1, the retainer ring 14 can be configured so that when the retainer ring 14 is arranged in the annular notch 32 of the nut body 16, a portion of the outer diameter 42 is generally flush with the diameter of nut body 16 when the nut body 16 is cylindrical. As will be discussed below with respect to the assembly of the fastener 10, the retainer ring 14 may be arranged within the annular notch 32 such that the retainer ring 14 is fixed and does not rotate with respect to the nut body 16.

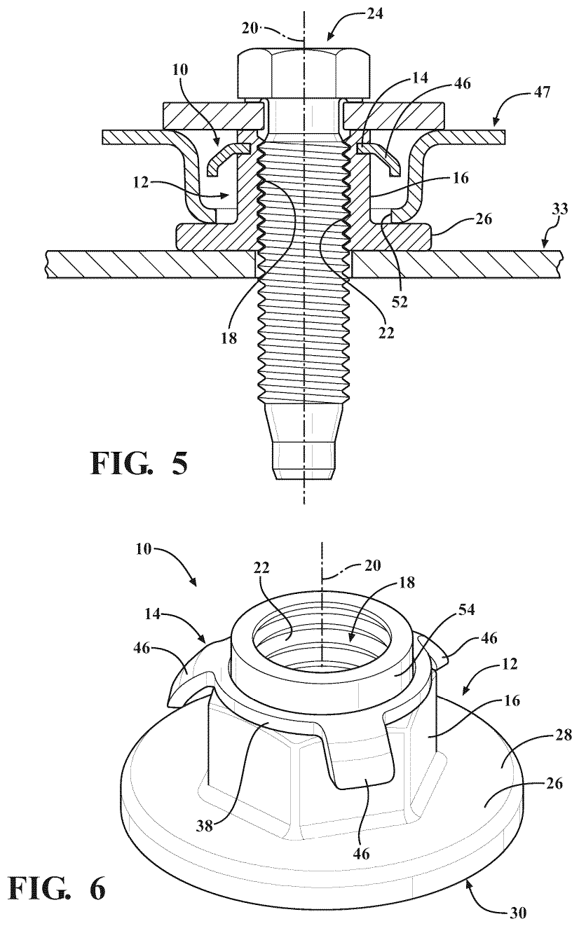

With reference again to FIGS. 1 and 2, the retainer ring 14 includes one or more retention features 46 coupled to and annularly spaced about the retainer ring 14. According to at least one aspect of the present disclosure, the retainer ring 14 may be made of an elastic material such as spring steel, plastic, or another material that can deflect and also provide a retention force. Thus, the one or more retention features 46 can include a first or unloaded position (FIGS. 3 and 5) and a second or deflected position (FIG. 4) and can be configured to deflect between the first position and the second position and to return to the first position.

As shown in FIG. 4, the one or more retention features 46 may be deflected by a portion of a second vehicle component 47. In other words, as the second vehicle component 47 is moved axially with respect to the longitudinal axis 20 and contacts the one or more retention features 46, the one or more retention features 46 deflect toward the nut body 16. Once the second vehicle component 47 is moved axially past the one or more retention features 46, the one or more retention features 46 return back to the first position (FIG. 5). However, in FIG. 5, once the one or more retention features 46 are in the first position, the one or more retention features 46 retain the second vehicle component 47 so that second vehicle component 47 cannot be easily removed from the fastener 10. Thus, the second vehicle component 47 may be temporarily arranged on the fastener 10 before it is securely fastened with the bolt 24, for example. The fastener 10 may provide the effect of a so-called “third hand” for an operator and may be desirable to temporarily maintain the lateral and axial position of the second vehicle component 47 relative to the nut body 16 and, thus, the first vehicle component 33, during manufacturing.

With reference to FIGS. 1 through 7, the one or more retention features 46 depend away from the longitudinal axis 20 and toward the flange 26. In some configurations, the retainer ring 14 includes four (4) retention features 46 coupled to the washer portion 38, as shown in FIGS. 1 and 2. In another configuration, and as shown in FIGS. 5 and 6, the retainer ring 14 includes three (3) retention features 46 coupled to the washer portion 38. However, other configurations of the retainer ring 14 may include more or fewer retention features 46. Each retention feature 46 includes a curved portion 48 that depends away from the longitudinal axis 20. Each retention feature 46 may include an end surface 50, and in the example shown in FIG. 1, the end surface 50 is parallel to the flange 26. The shape of each retention feature 46 may help orient the fastener 10 with respect to an opening 52 of the second vehicle component 47, as shown in FIG. 3. Additionally, when the retainer ring 14 includes more than one retention feature 46, the shape of the retention features 46 can help centralize the load placed on each retention feature 46 by the second vehicle component 47 during assembly.

In another configuration, as shown in FIG. 8, the fastener 10′ may include the nut 12 as described above and a retainer ring 14′. The retainer ring 14′ can have one or more retention features 46′ that depend away from the longitudinal axis 20 and away from the flange 26. Similar to abovementioned configurations, the one or more retention features 46′ can include a curved portion 48′ and an end surface 50′ that is parallel to the flange 26. In this configuration, the one or more retention features 46′ can provide a hook or ledge so that the second vehicle component 47, for example, may be temporarily arranged on the one or more retention features 46′ before being oriented on the nut 12 and fastened to the nut 12. The one or more retention features 46′ can support the second vehicle component 47 to prevent inadvertent axial movement of the second vehicle component 47 toward the flange 26 with respect to the longitudinal axis 20 and inadvertent lateral movement of the second vehicle component 47 with respect to the nut 12.

The fastener 10 may be manufactured using one or more methods. In one example, the retainer ring 14 may be coupled to the nut 12 by hammering or rolling a portion of the nut 12. With reference to FIG. 6, the retainer ring 14 may first be inserted over a collar 54 of the nut body 16, which extends axially from the nut body 16 with respect to the longitudinal axis 20. Next, the collar 54 may be hammered, rolled, or otherwise finished using another manufacturing technique so that the retainer ring 14 is secured (i.e., fixed) within the annular notch 32 and with respect to the nut body 16. In another example, the fastener 10 may be insert molded or over molded.

In assembly, the fastener 10, and more particularly the lower surface 30 of the flange 26, may be coupled to the first vehicle component 33 via welding, heat staking, or another means commonly used in automotive manufacturing. Next, the second vehicle component 47 may be arranged onto the fastener 10 such that a portion of the second vehicle component 47 deflects the one or more retention features 46 towards the nut body 16 from a first position (FIG. 3) to a second position (FIG. 4) so that the second vehicle component 47 can move axially past the one or more retention features 46. Once the second vehicle component 47 axially passes along each of the one or more retention features 46, the one or more retention features 46 return to the first position, as shown in FIG. 5. Finally, the bolt 24 may be inserted into the through hole 18 of the nut body 16 and fastened so that the threads of the nut 12 mate with the threads 22 of the nut body 16.

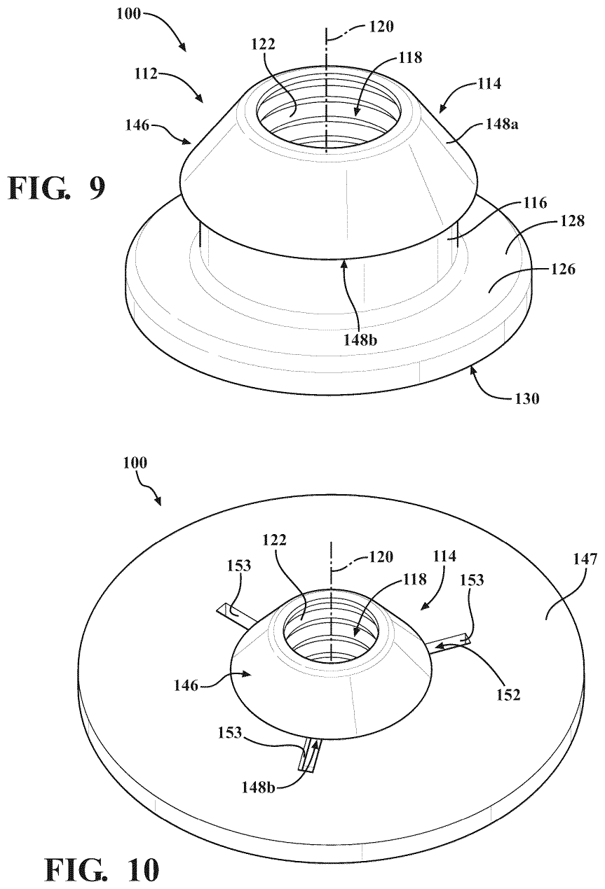

FIGS. 9 and 10 provide another illustrative configuration of a fastener 100. This configuration is similar in many respects to the configurations of FIGS. 1-8. Accordingly, the descriptions of the configurations are hereby incorporated into one another, and description of subject matter common to the configurations may not be repeated.

With reference to FIG. 9, the fastener 100 includes a nut 112 and a retainer ring 114. The nut 112 includes a nut body 116 that can be cylindrical or another shape. The nut body 116 includes a through hole 118 extending along a longitudinal axis 120. The through hole 118 can include threads 122, which are configured to correspond with threads of a bolt or another fastener (not shown). The nut 112 can have a flange 126 extending radially away from the nut body 16 and including an upper surface 128 and a lower or mating surface 130. The lower surface 130 may be configured so that the nut 112 may be welded, glued, heat staked, compression mounted, or otherwise coupled to another component (not shown).

With continued reference to FIG. 9, the retainer ring 114 may be integrally formed with the nut body 116. According to an aspect of the present disclosure, the nut 112 and the retainer ring 114 may be formed using a rigid material such as metal, hard plastic, hard rubber, or another material used for fasteners in the automotive industry, for example. The retainer ring 114 may be defined as a rigid integral component of the nut 112 which does not easily deflect under force. The retainer ring 114 can include a retention feature 146 that may be defined by a contact surface 148a extending away from the longitudinal axis 120 and an annular lip 148b generally perpendicular to the longitudinal axis 120 and extending away from the nut body 116. The contact surface 148a may be angled with respect to the longitudinal axis 120 and configured to deflect a portion of a component, such as a vehicle component 147, being attached to the fastener 100, for example. Additionally or alternatively, the contact surface 148a may be configured to locate the fastener 100 within an opening 152 of the component 147 and distribute a load (i.e., force) on one or more portions of the opening 152.

In assembly, the vehicle component 147 may be coupled to and held by the fastener 100 before a bolt or other fastener (not shown) is secured to the nut 112. The component 147 includes an opening 152 with one or more slots 153 annularly spaced around the opening 152. Contrary to the abovementioned configurations, the component 147 is configured to deflect rather than the fastener 100. Thus, when the component 147 is inserted on the fastener 100, the slots 153 surrounding the opening 152 allow a portion of the component 147 to deflect so that the component 147 may move axially along the longitudinal axis 120 past the retainer ring 114. As shown in FIG. 10, the retention feature and, more specifically, the annular lip 148a, axially retains a portion of a component 147 attached to the fastener 100 with respect to the longitudinal axis. In other words, the annular lip 148a prevents the component 147 from easily being removed from the fastener 100. Additionally, when the component 147 is coupled to the fastener 100, the component 147 is laterally retained with respect to the nut body 116. The present configuration may be desirable as it can provide a so-called “third hand” for an operator during manufacturing by temporarily holding the component 147 while the operator is arranging a bolt or fastener in the through hole 118, for example.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A fastener, comprising:
a nut comprising:
a nut body comprising a threaded through hole extending along a longitudinal axis,
a flange extending away from the nut body and comprising an upper surface and a lower surface, and
an annular notch comprising a notch diameter and a notch thickness and arranged in the nut body, the annular notch being spaced axially from the flange with respect to the longitudinal axis; and
a retainer ring arranged in the annular notch, comprising:
a washer portion comprising an inner diameter, an outer diameter, and a thickness, and
one or more retention features coupled to and depending from the washer portion in a first position;
wherein the one or more retention features are configured to deflect between the first position and a second position and return to the first position.

2. The fastener of claim 1, wherein the nut body is cylindrical.

3. The fastener of claim 1, wherein the nut body is hexagonal.

4. The fastener of claim 1, wherein the lower surface of the flange is configured to be welded, glued, heat staked, or compression mounted to another component.

5. The fastener of claim 1, wherein the retainer ring is fixed in the annular notch by a collar such that the retainer ring does not rotate about the longitudinal axis with respect to the nut.

6. The fastener of claim 1, wherein the retainer ring is made of a spring metal material.

7. The fastener of claim 1, wherein the nut is made of a metal, plastic, or hard rubber material.

8. The fastener of claim 1, wherein the one or more retention features depend away from the longitudinal axis and toward the flange.

9. The fastener of claim 1, wherein the one or more retention features further comprise a curved portion and an end surface that is generally parallel to the flange.

10. The fastener of claim 1, wherein the one or more retention features are configured to retain a component laterally with respect to the nut and axially with respect to the longitudinal axis.

11. A fastener, comprising:
a nut, comprising:
a nut body comprising a threaded through hole extending along a longitudinal axis,
a flange extending away from the nut body and comprising an upper surface and a lower surface, and
an annular notch comprising a notch diameter and a notch thickness and arranged in the nut body, the annular notch being spaced axially from the flange with respect to the longitudinal axis; and
a retainer ring arranged in the annular notch, comprising:
a washer portion comprising an inner diameter, an outer diameter, and a thickness, and
a retention feature coupled to and depending away from the washer portion and axially away from the flange.

12. The fastener of claim 11, wherein the retention feature further comprises a curved portion and an end surface that is parallel to the flange.

13. The fastener of claim 11, where the retention feature is configured to temporarily support a component being secured to the fastener.

14. The fastener of claim 11, wherein the retention feature is configured to support a component to prevent inadvertent axial movement of the component toward the flange with respect to the longitudinal axis and inadvertent lateral movement of the component with respect to the nut.

15. A fastener, comprising:
a nut, comprising:
a nut body comprising a threaded through hole extending along a longitudinal axis, and
a flange extending away from the nut body and comprising an upper surface and a lower surface; and
a retainer ring integrally formed with the nut comprising a retention feature, comprising:
a contact surface extending away from the nut body, and
an annular lip perpendicular to the longitudinal axis and extending away from the nut body.

16. The fastener of claim 15, wherein the nut and retainer ring are made of a metal, hard plastic, or hard rubber material.

17. The fastener of claim 15, wherein the contact surface is angled with respect to the longitudinal axis and configured to deflect a component being attached to the fastener.

18. The fastener of claim 17, wherein the contact surface locates the fastener within an opening of the component and distribute a load on one or more portions of the opening.

19. The fastener of claim 15, wherein the annular lip axially retains a portion of a component attached to the fastener with respect to the longitudinal axis.

20. The fastener of claim 19, wherein the component is laterally retained with respect to the nut body.
